(19) United States
(12) Patent Application Publication
(10) Pub. No.: US 2026/0308950 A1
(43) Pub. Date: Oct. 8, 2026

(54) VEHICLE DOOR ACTUATOR

(71) Applicant: Rivian IP Holdings, LLC, Irvine, CA (US)

(72) Inventors: Reggie Kartak Lau, Irvine, CA (US); Kostandinos Papanikolaou, Corona, CA (US); Vijay Srinivasan, Orange, CA (US)

(73) Assignee: Rivian IP Holdings, LLC, Irvine, CA (US)

(21) Appl. No.: 19/097,981

(22) Filed: Apr. 2, 2025

(51) Int. Cl. E05B 81/14; E05B 77/24; E05B 81/06; E05B 81/34; E05B 81/74; E05B 83/36

(52) U.S. Cl. CPC E05B 81/14; E05B 77/24; E05B 81/06; E05B 81/34; E05B 81/74; E05B 83/36

(57) ABSTRACT

Vehicle door actuation is provided. A system includes an actuator to couple a first linkage of a door latch mechanism with a second linkage of an interior release handle. The actuator includes a motor to actuate the actuator to decouple the first linkage from the second linkage responsive to a receipt of a first instruction to prevent internal operation of the vehicle door. The system can actuate, responsive to receipt of a second instruction, the actuator to couple the first linkage with the second linkage to couple the interior release handle with the door latch mechanism to permit internal operation of the vehicle door.

### INTRODUCTION

Vehicles can include openings for egress or ingress. For example, the openings can be locked, unlocked, or otherwise secured.

### SUMMARY

This disclosure is generally directed to systems and methods for vehicle door actuators. The vehicle door actuator can disengage an internal door control. For example, to prevent a rear seat occupant from inadvertently opening a door, an internal door release can be decoupled from a door latch assembly. When the internal door control is not disengaged, it can be used to open the door, even in the absence of vehicle power. Such an actuator can include two cylindrical members, one being receivable into the other. One of the cylindrical members can couple with a first cable or other linkage coupled with the internal door release. The other cylindrical member can couple with a second cable or other linkage coupled with a door latch assembly. A motor can selectively couple the first cylindrical member with the second cylindrical member. For example, the motor can rotate one of the cylindrical members about the other cylindrical member to radially align a protrusion of one cylindrical member with a channel of the other. When aligned, the protrusion can be received into a portion of the channel to telescoping one of the cylindrical members into the other. When unaligned, the protrusion can prevent the telescoping of the cylindrical members.

In at least one aspect, a system to operate a vehicle door is provided. The system can include an actuator to couple a first linkage of a door latch mechanism with a second linkage of an interior release handle. The actuator can include a motor. The motor can actuate the actuator to decouple the first linkage from the second linkage responsive to a receipt of a first instruction to prevent internal operation of the vehicle door. The motor can actuate, responsive to receipt of a second instruction, the actuator to couple the first linkage with the second linkage to couple the interior release handle with the door latch mechanism to permit internal operation of the vehicle door.

The actuator can include a first member to receive a first end of the first linkage. The first member can include a body having a cylindrical portion extending along a first direction. The actuator can include a second member overlapping with the first member along the first direction. At a first end of the second member, according to a first radial position between the first member and the second member, the actuator can arrest a movement between the first member and the second member along the first direction according to an interference between a protrusion of one of the first member or the second member with a sidewall of a channel of the other of the first member or the second member. At a first end of the second member, according to second radial position between the first member and the second member, the actuator can allow telescopic movement of one of the first member or the second member into the other of the first member or the second member.

The actuator can include a first member including an inner sidewall defining an axial opening extending along a first direction to receive a second member and a protrusion extending from the inner sidewall. The actuator can include the second member including a channel in an outer surface of a cylindrical portion to receive the protrusion, the channel including a first portion extending along the first direction and a second portion extending circumferentially about the cylindrical portion.

A first face of a first member of the actuator can define a notch to receive the first linkage. A body of the first member can define an opening in fluid communication with the notch to receive a first end stop of the first linkage and retain the first end stop along a second face of the first member disposed oppositely from the first face of the first member. A first face of a second end of a second member can define a notch to receive the second linkage.

The system can include a mating gear to couple the motor with a plurality of gear pins of a first member of the actuator.

The actuator can include a first member including a various tapered gear pins to mate with a mating gear coupled with a shaft of the motor.

The system can include a housing. The housing can include a first member of the actuator. The housing can include a second member of the actuator. The housing can include the motor. The housing can include a spring having a first end abutting a face of the second member and a second end abutting an inner sidewall of the housing. In a retracted state, the spring aligns a protrusion of the second member with a first portion of a channel of the first member extending along a first direction. In an extended state, the spring aligns, along the first direction, the protrusion of the second member with a second portion of the channel of the first member extending circumferentially about a cylindrical portion of the first member. The first portion of the channel and the second portion of the channel can be in fluid communication at an intersection point. The motor can rotate the first member, with the spring in an extended state, to a first radial position and a second radial position. In the first radial position, the actuator can radially align the protrusion with the intersection point. In a second radial position, the actuator can radially offset the protrusion from the intersection point.

The system can include a controller. The controller can receive, from a user interface, an indication to disengage the interior release handle. The controller can generate, responsive to the indication, a control signal to rotate a first member to the actuator relative to a second member of the actuator to decouple the interior release handle from the door latch mechanism.

The system can include a sensor to detect an indication of a radial position of a first member of the actuator. The system can include a controller to receive, from the sensor, the indication of the radial position of the first member and cause a display indicating a state of the actuator based on the radial position.

In at least one aspect, a method is provided. The method can include actuating, responsive to a receipt of an instruction, an actuator to couple a first linkage coupled with a second linkage to couple an interior release handle with a door latch mechanism to permit internal operation of the door.

The method can include maintaining, upon a loss of power to the actuator, a position of the actuator.

Actuating the actuator to couple the first linkage with the second linkage can include engaging a motor to rotate a protrusion of a first member to align the protrusion with a first channel portion of a second member to pass the protrusion into the channel upon an actuation of the interior release handle to transfer a displacement of the first linkage to the second linkage.

The actuator can include a first member to receive a first end of the first linkage, the first member including a body having a cylindrical portion extending along a first direction. The actuator can include a second member overlapping with the first member along the first direction. According to a first radial position between the first member and the second member, the actuator can arrest a movement between the first member and the second member along the first direction according to an interference between a protrusion of one of the first member or the second member with a sidewall of a channel of the other of the first member or the second member. According to a second radial position between the first member and the second member, the actuator can allow telescopic movement of one of the first member or the second member into the other of the first member or the second member.

The actuator can include a first member including an inner sidewall defining an axial opening extending along a first direction to receive a second member and a protrusion extending from the inner sidewall. The second member can include a channel in an outer surface of a cylindrical portion to receive the protrusion. The channel can include a first portion extending along the first direction and a second portion extending circumferentially about the cylindrical portion.

A first face of a first member of the actuator can define a notch to receive the first linkage. A body of the first member can define an opening in fluid communication with the notch to receive a first end stop of the first linkage and retain the first end stop along a second face of the first member disposed oppositely from the first face of the first member. A first face of a second end of a second member can define a notch to receive the second linkage.

Actuating the actuator to couple the first linkage with the second linkage can include mating pin gears of a motor with a first member, to align a protrusion of the first member with a first channel portion of a second member.

The method can include detecting a radial position of a rotatable member of the actuator; and presenting the detected radial position on an in-vehicle display.

The method can include actuating the actuator to decouple the first linkage from the second linkage by aligning a protrusion of a first member with a second channel portion of a second member. The second channel portion can extend perpendicular to a force applied to the first linkage by the interior release handle.

In at least one aspect, an electric vehicle including a door is provided. The door can include a door latch mechanism to latch the door closed. The door latch mechanism can couple with a first linkage. The door can include an interior release handle coupled with a second linkage. The door can include an actuator to couple the first linkage with the second linkage. The actuator can include a motor to actuate the actuator to decouple the first linkage from the second linkage responsive to a receipt of a first instruction to prevent internal operation of the door and actuate the actuator to couple the first linkage with the second linkage responsive to a receipt of a second instruction to permit internal operation of the door.

The actuator of the electric vehicle can include a first member to receive a first end of the first linkage, the first member including a body having a cylindrical portion extending along a first direction. The actuator can include a second member overlapping with the first member along the first direction. At a first end of the second member, according to a first radial position between the first member and the second member, the actuator can arrest a movement between the first member and the second member along the first direction according to an interference between a protrusion of one of the first member or the second member with a sidewall of a channel of the other of the first member or the second member. At a first end of the second member, according to second radial position between the first member and the second member, the actuator can allow telescopic movement of one of the first member or the second member into the other of the first member or the second member.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. The foregoing information and the following detailed description and drawings include illustrative examples and should not be considered as limiting.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 depicts a door including an actuator, in accordance with some aspects.

FIG. 2 depicts an electric vehicle, in accordance with some aspects.

FIG. 3 is a detail view of components of an actuator, in accordance with some aspects.

FIG. 4 depicts a housing including the actuator, in accordance with some aspects.

FIG. 5 depicts a block diagram for a data flow of a method of door operation for a vehicle, according to some aspects.

### DETAILED DESCRIPTION

Following below are more detailed descriptions of various concepts related to, and implementations of, methods, apparatuses, and systems of vehicle door or handle actuation. The various concepts introduced above and discussed in greater detail below may be implemented in any of numerous ways.

Solutions, such as mechanical locks or software-based controls, often do not address operational criteria, such as an operation of the door after a battery or other power loss. For example, an interior release handle can open a door even if power is disabled, where the door operation has not been disabled (e.g., by a manual selection of rear doors by a driver or other front-seat occupant).

According to the present disclosure, an actuator-based solution couples and decouples linkages between the interior release handle and a door latch. This actuator, positioned between the door latch and the interior release handle, operates based on control inputs. For example, the control inputs can include a user input received from a user interface such as an in-vehicle switch or in-vehicle display. The actuator can fit within the vehicle's side door structure, as can protect the actuator and related components from water or other environmental contaminants.

The actuator system can couple a first linkage of a door latch mechanism with a second linkage of an interior release handle, using a motor to permit or prevent internal door operation based on received instructions. This system incorporates structural components such as a first member and a second member, which can be provided as generally cylindrical (or include a cylindrical portion), allowing for telescopic movement between the respective first and second members. One of the members can include a channel configured to receive a protrusion of the other member to arrest or permit the telescopic movement according to a radial position between the first and second members.

A first portion of the channel can extend axially along a surface of the cylindrical portion, such that when the two members telescope, the protrusion moves along the first portion of the channel. In such a configuration, the actuation of the door latch mechanism can transfer a displacement to the first linkage coupled with the first member. However, because the first member can telescope relative to the second member, the translation of the first linkage does not result in a movement of the second member or the second linkage. Accordingly, in such a configuration, the actuation of the interior release handle does actuate the door latch.

A second portion of the channel can extend circumferentially about the cylindrical portion. The second portion of the channel can intersect with the first portion at an intersection point. Accordingly, a relative rotation between the first and second members can move a protrusion between a first and second portion to prevent the members from telescoping into one another. For example, a motor can rotate the members to move the protrusion away from the first portion of channel. In such a configuration, the actuation of the door latch mechanism can transfer a displacement to the first linkage coupled with the first member on to the second member (based on a coupling of the protrusion with a sidewall of the second portion of the channel). Accordingly, in such a configuration, the actuation of the interior release handle can actuate the door latch according to a transferred movement of the first linkage, to the first and second member, and onto the second linkage coupled with the door latch. Upon a loss of power to the motor, the motor may not activate to transition between configurations. However, even upon the loss of power, the interior release handle will continue to operate in a previously selected configuration.

The motor can couple with the first or second member using tapered gears (e.g., tapered gear pins) as can self-align a connection, resolving minor misalignment when the first and second members are displaced by operating the interior release handle to unlatch the door latch mechanism. Moreover, a motor position can be sensed or stored by a controller, as may further provide feedback to a display, or commands to actuate the motor to transition between radial positions according to a selected configuration (e.g., permitting or preventing operation of the interior release handle).

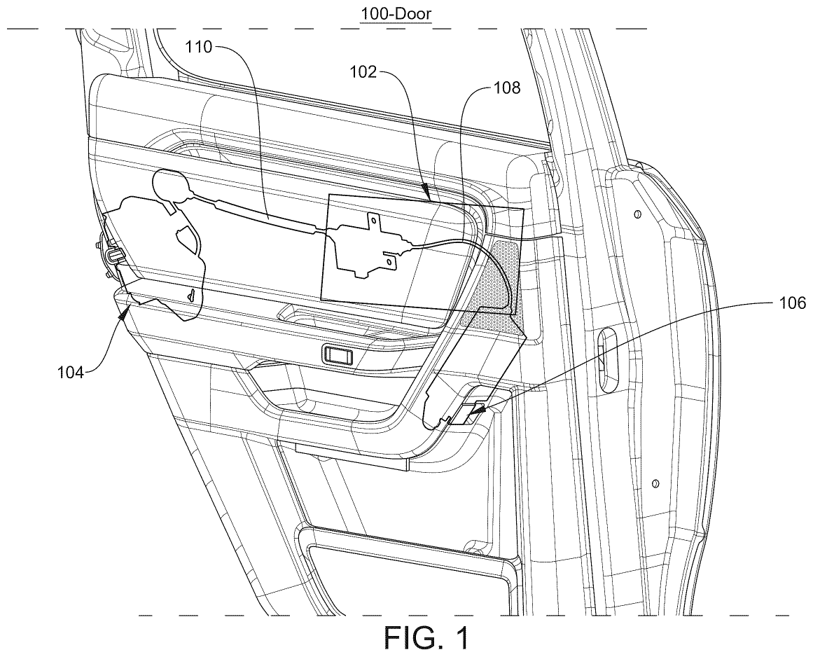

FIG. 1 depicts a door 100 including an actuator 102, in accordance with some aspects. The door 100 includes an interior release handle 106 coupled with a first linkage 108. The door 100 includes a door latch mechanism 104 coupled with the actuator 102 by a second linkage 110. The various components are depicted within an example of a rear door 100 of an electric vehicle. However, such components can be included for various latch mechanisms 104 coupled with latches. For example, the actuator 102 can couple front door latches, hood latches, or hatchback latches with a corresponding release mechanism to transfer mechanical forces therebetween.

The door 100 includes an actuator 102 designed, constructed, or operational to selectively couple a door latch mechanism 104 with the interior release handle 106. For example, a first end of the actuator 102 can couple with a first linkage 108 coupled with the interior release handle 106 and a second end of the actuator 102 can couple with a second linkage 110 coupled with the door latch mechanism 104. The actuator 102 includes a motor and other components to selectively couple the first linkage 108 with the second linkage 110. For example, the motor can rotate components to engage or disengage the second linkage 110 from the first linkage 108. The actuator 102 can operate based on inputs received from a control system (e.g., a selection switch of a user interface, microprocessor, or other control circuitry which can be referred to as a controller). For example, the controller can store a state of the actuator 102 or receive a sensor signal indicative of a state of the actuator 102 and display an indication of the state.

The door 100 includes a door latch mechanism 104 designed, constructed, or operational to selectively couple a door 100 with a door frame to secure or release the door 100 from the door frame. For example, the door latch mechanism 104 can include a spring-loaded latch to couple with a striker of the doorframe, rotating pawl and ratchet mechanism, or motorized linear actuated latch to latch the door 100 with the door frame in a closed position. The door latch mechanism 104 can operate based on a mechanical force received via the second linkage 110. The door latch mechanism 104 can further couple with additional linkages to open (or prevent opening) of the door 100. For example, the door latch mechanism 104 can couple with an exterior handle (and exterior lock), an electronic door control, or other mechanisms.

The door 100 includes an interior release handle 106 designed, constructed, or operational to open a door 100 from a passenger compartment of a vehicle. For example, the interior release handle 106 can include a lever configured to translate an applied force into a motion of a linkage mechanism to translate the linkage mechanism. The applied force can refer to a pulling or pushing of the lever, or a translation of another input actuator (e.g., a push-button mechanism). The interior release handle 106 can aid an occupant to open a vehicle form inside a vehicle (e.g., where the linkage mechanism is coupled with the door latch mechanism 104). The release handle 106 can couple with a first linkage 108 of the linkage mechanism. The interior release handle 106 can be provided as a primary or secondary handle. For example, the interior release handle 106 can be provided as an only interior release handle, or as a backup to an electronic or other system. The interior release handle 106 can interfere with the controller to inhibit its operation. For example, the controller can receive an indication to prevent operation of a door 100 so that a rear seat occupant does not inadvertently open the door 100.

The door 100 includes a linkage mechanism designed, constructed, or operational to transfer mechanical forces between the actuator 102, the door latch mechanism 104, or the interior release handle 106. For example, the linkage mechanism can include a first linkage 108 to transfer forces from the interior release handle 106 to the actuator, and a second linkage 110 to transfer forces from the actuator 102 to the door latch mechanism 104. Either of the second linkage 110 or the first linkage 108 can include one or more components to transfer the forces, as may include cables, rods, levers, pivots, gears, or other mechanical elements. For example, the linkages can include an inner cable sheathed in a protective casing coupled with the door 100. When the actuator 102 is configured to permit operation of the interior release handle 106, the second linkage 110 and the first linkage 108 can operate together, such that a mechanical force applied to the first linkage 108 is applied to the second linkage 110 via the actuator 102. When the actuator 102 is configured to prevent operation of the interior release handle 106, the second linkage 110 and the first linkage 108 can operate separately. For example, a mechanical force applied to the first linkage 108 may not be conveyed onward to the second linkage 110, such that the actuation of the interior release handle 106 does not actuate the door latch mechanism 104.

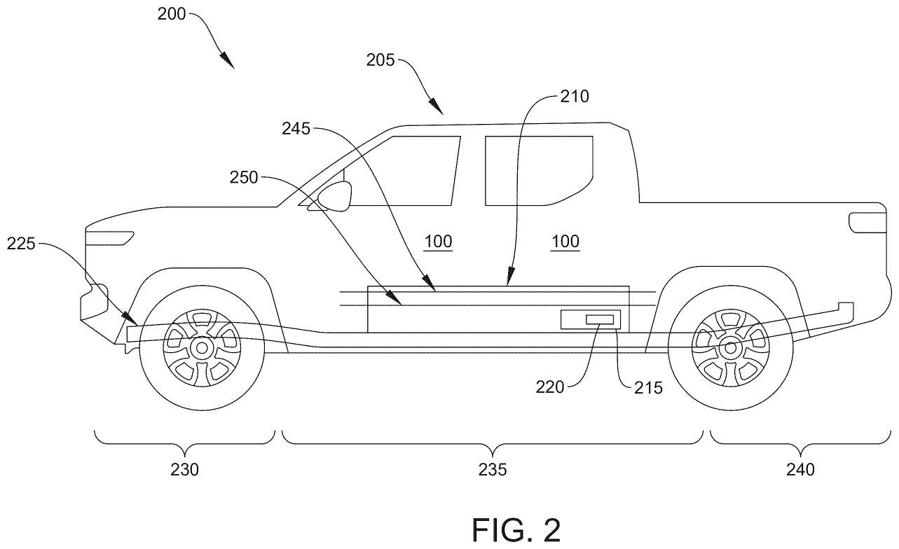

FIG. 2 depicts an example cross-sectional view of an electric vehicle 200 installed with at least one battery pack 210. Electric vehicles 200 can include electric trucks, electric sport utility vehicles (SUVs), electric delivery vans, electric automobiles, electric cars, electric motorcycles, electric scooters, electric passenger vehicles, electric passenger or commercial trucks, hybrid vehicles, or other vehicles such as sea or air transport vehicles, planes, helicopters, submarines, boats, or drones, among other possibilities. The battery pack 210 can also be used as an energy storage system to power a building, such as a residential home or commercial building. Electric vehicles 200 can be fully electric or partially electric (e.g., plug-in hybrid) and further, electric vehicles 200 can be fully autonomous, partially autonomous, or uncrewed. Electric vehicles 200 can be human operated or non-autonomous. Electric vehicles 200 such as electric trucks or automobiles can include on-board battery packs 210, batteries 215 or battery modules 215, or battery cells 220 to power the electric vehicles.

The electric vehicle 200 can include a chassis 225 (e.g., a frame, internal frame, or support structure). The chassis 225 can support various components of the electric vehicle 200. For example, the chassis 225 can include door frames to receive the doors 100. Doors 100 can include one or more front doors 100 or one or more rear doors 100. Moreover, the chassis 225 can selectively couple with panels such as a hood panel, rear hatch, trunk, tailgate, or tonneau cover. For example, the chassis 225 can include strikers to latch with latch mechanisms of the various panels. Any of the various panels, or other latch assemblies (e.g., a glovebox compartment) can be coupled with an actuator 102 of the present disclosure. The chassis 225 can span a front portion 230 (e.g., a hood or bonnet portion), a body portion 235, and a rear portion 240 (e.g., a trunk, payload, or boot portion) of the electric vehicle 200.

The battery pack 210 can be installed or placed within the electric vehicle 200. For example, the battery pack 210 can be installed on the chassis 225 of the electric vehicle 200 within one or more of the front portion 230, the body portion 235, or the rear portion 240. The battery pack 210 can include or connect with at least one busbar, e.g., a current collector element. For example, the first busbar and the second busbar can include electrically conductive material to connect or otherwise electrically couple the battery 215, the battery modules 215, or the battery cells 220 with other electrical components of the electric vehicle 200 to provide electrical power to various systems or components of the electric vehicle 200. The systems or components of the electric vehicle 200 can include a motor of the actuator 102, vehicle displays, or other systems. A battery disconnect switch can be actuated to remove power from vehicle systems upon detection of a disconnection criterion, such as a detection of an event that can relate to the battery 215 (e.g., a g-force sensor or input of a perception system).

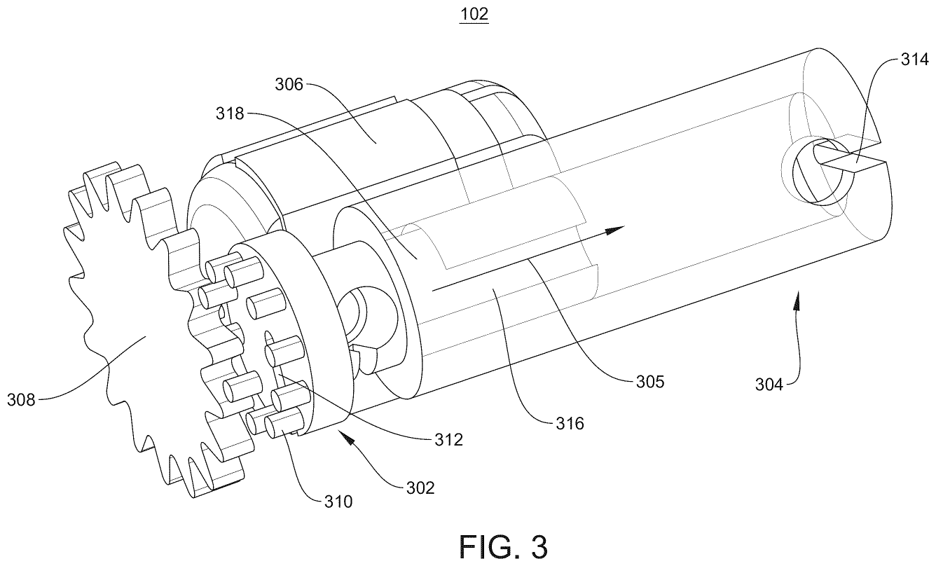

FIG. 3 is a detail view of components of an actuator 102, in accordance with some aspects. The actuator 102 can facilitate the coupling and decoupling of a linkage mechanism of a vehicle door 100. The actuator 102 can include a motor 306. When engaged with an engagement feature and upon actuation, the motor 306 can rotate a first member 302 relative to a second member 304. For example, the motor 306 can be coupled with a mating gear 308 which can couple with a corresponding engagement feature of the first member 302. The engagement feature can include a gear wheel or gear pins 310.

The actuator 102 includes a first member 302 and a second member 304 designed, constructed, or operational to selectively mate with one-another. The first member 302 can couple with the second linkage 110 and the second member 304 can couple with the first linkage 108 (or the actuator 102 can be inverted to couple with opposite linkages). For example, the second linkage 110 can be received into a first notch 312 in a first face of the first member 302, to retain an end stop against an opposite face of the first member 302. The first linkage 108 can be received into a second notch 314 in a face of the second member 304. The first linkage 108 can include an end stop retained against the face of the second member 304.

The first member 302 can include a cylindrical portion configured for receipt within an inner sidewall of an axial opening of the second portion 304. Such a receipt can be referred to as telescopic motion of the first member 302 and second member 304. During all or a portion of the telescopic motion, the first member 302 can overlap with the second member 304 along a direction 305 of the axial opening. The cylindrical portion can include a protrusion configured to be received into a channel of the second member 304. For example, the channel can be a channel in an outer surface of a cylindrical portion of the second member 304.

The actuator 102 includes a motor 306 designed, constructed, or operational to rotate the first member 302 relative to the second member 304. For example, the motor 306 can include a DC motor, such as a stepper motor or servo-motor to control a relative rotation of the respective members 302, 304. According to an offset between a channel width and the protrusion, the accuracy of the rotation can vary. For example, for relatively narrow protrusions and wide channels, the rotation of the first member 302 and second member 304 can exhibit clearance between the protrusion and channel such that misalignments may not inhibit operation. A first portion 316 and second portion 318 of the channel can be contiguous or otherwise in fluid communication with one another. The protrusion can transition between the first portion 316 and the second portion 318 via an intersection point.

The channel can include a first portion 316 and a second portion 318 to form an internal guiding structure of the actuator 102. The first portion 316 of the channel can extend along a direction 305 of the axial opening. Accordingly, when the protrusion of the first member 302 is disposed within the first portion 316 of the channel, the actuator 102 can allow telescopic movement between the first member 302 and the second member 304, with the first member 302 and the second member 304 overlapping in the direction 305. The telescopic motion can include a retracted state at one end of travel of the protrusion relative to the first portion 316 of the channel, and an extended state at another end of travel of the protrusion relative to the first portion 316 of the channel (e.g., at an intersection point between the first portion 316 and the second portion 318). Thus, when an interior release handle 106 coupled with the first linkage 108 mechanically displaces the first linkage 108 and second member 304 (e.g., by transferring a force from the end stop to an inner face of the second member 304), the mechanical displacement is not transferred to the first member 302. For example, the second member 304 can move freely along a direction 305 of the axial opening, with the stationary protrusion shifting along the first portion of the channel in the direction 305. In such a configuration, the first member 302 can maintain a coupling between the engagement feature and the motor 306 (e.g., between the mating gear 308 and the gear pins 310).

The motor 306 can rotate the first member 302 relative to the second member 304 to translate the protrusion into a second portion 318 of the channel, the second portion 318 extending circumferentially about the cylindrical portion of the first member 302. The circumferential extension can refer to an extension which is perpendicular to the first portion, or which varies somewhat therefrom. For example, the second portion 318 can extend somewhat along the direction 305 of the axial opening. When the protrusion is in the second portion 318 of the channel, a movement of the second member 304 can transfer to the first member 302, according to a coupling (e.g., interference) between the sidewall of the second portion 318 and the protrusion to arrest a relative movement of the first member 302 and the second movement 304 in the direction 305. Accordingly, the actuator 102 can inhibit telescopic movement between the first member 302 and the second member 304, so that a force or motion is transferred between the first linkage 108 and the second linkage 110. For example, a movement of the first linkage 108 initiated by the actuation of the interior release handle 106 can transfer a mechanical force and displacement from the end stop of the first linkage 108 to the second member 304, from the sidewall of the second portion 318 of the channel to the first member 302, from the first member 302 to the second linkage 110 through the end stop of the second linkage 110, and on to the door latch mechanism 104 to unlatch the door 100, so that it can be opened.

The actuator 102 can include a mating gear 308 and gear pins 310 or other engagement feature coupled to mate with one another to transfer rotational forces from the motor 306 to a first member 302. The mating gear 308 is a gear component meshed with the motor (e.g., via a motor shaft). The mating gear 308 and engagement feature can decouple from one another when the interior release handle 106 is actuated to actuate the door latch mechanism 104. Accordingly, the mating gear 308 and engagement feature can include an alignment feature to mesh with one-another. For example, tapered gear pins 310 can be provided to align the gear pins 310 with the mating gear 308 upon release of the interior release handle 106.

The motor 306 can interface with a controller to receive instructions to translate between a mode of operation permitting operation of the interior release handle 106 to open the door 100 and another mode of operation permitting operation of the interior release handle 106 to open the door 100. The instructions can be received according to a serial communications channel, or according to an application of power by the controller. For example, the motor 306 can include a processor to couple with a communication interface of a controller, or include reversable polarity power inputs. The actuator 102 can include a sensor to indicate a position of the motor 306, the mating gear 308, the gear pins 310, the first member 302 or other second member 304, or other components. Some controllers can include a memory device to store a current position of the actuator, as may increase a confidence of a position detected by the sensor, or can be used instead of a sensor to maintain a position of actuator 102.

Various features of the respective first member 302 and second member 304 can be inverted relative to the depicted illustrative example. For example, the first member 302 can include the channel and the second member 304 can include the protrusion, or the second member 304 can be received into an opening of the first member 302. Moreover, the channel can be defined by an inner sidewall of an outer surface or an inner surface of the first member 302 or the second member 304. Further, the end stops can be substituted with fasteners or other components to couple with the actuator.

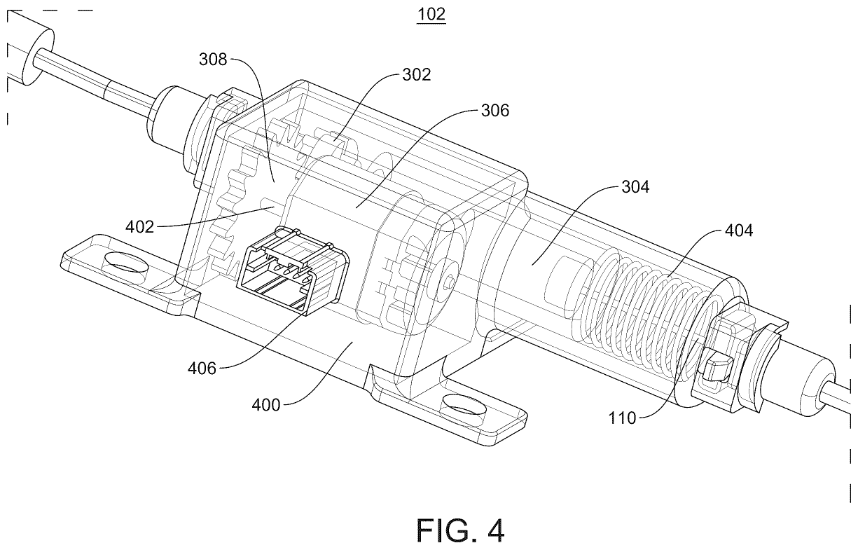

FIG. 4 depicts a housing 400 including the actuator 102, in accordance with some aspects. The housing 400 can enclose and protect the internal elements of the system, and maintain an orientation of the first member 302 and second member 304. For example, the housing 400 can house the first member 302, second member 304, and the motor 306.

The housing 400 can include a surface to abut a spring element 404 between the second member 304 and the housing surface. For example, the surface can include a spring seat or other sidewall of the housing 400. When the interior release handle 106 is actuated, translating the second member 304, the translation can compress the spring element 404 to apply a spring force to return the interior release handle 106 to a normal position. By positioning the spring element 404 between the second member 304 and the housing 400, the spring force can return the interior release handle 106 to the normal position regardless of whether the protrusion is disposed in a first portion 316 or second portion 318 of the channel. Moreover, the spring element 404 can provide tension, as may maintain a coupling of the first member 302 and second member 304, as well as the coupling of the actuator 102 with the linkage mechanism. A retracted state can correspond to a compression of the spring element 404 relative to an extended state. However, in the extended state, the spring element 404 can continue to exert some tensile force to maintain tension between the actuator 102 and the second linkage 110, the first linkage 108, the door latch mechanism 104, or the interior release handle 106.

The housing 400 includes a connector 406 designed, constructed, or operational to facilitate electrical connections with a controller of the vehicle 200. For example, the connector 406 can couple with the controller to receive instructions to permit or prevent internal operation of the vehicle door. The instructions can be received as a discrete signal for motor 306 actuation or as serial link commands for communication and control. That is, the motor 306 can include a processor communicatively coupled with the controller (e.g., over a serial link), or the connector 406 can couple discrete power or control signals for the motor 306. Upon a receipt of the instruction, the motor 306 can transmit a force to the mating gear 308 (e.g., via a motor shaft 402), to rotate the first member 302 relative to the second member 304. The connector 406 can further provide an indication of a relative rotation between the first member 302 and the second member 304. For example, the motor 306 can couple with a sensor to detect a position of the motor 306 or other components of the actuator 102 to determine a relative radial position between first member 302 and the second member 304.

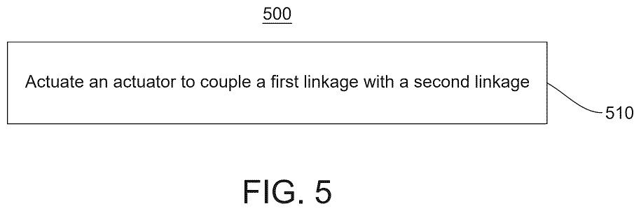

FIG. 5 depicts a block diagram for a data flow of a method 500 of door operation for a vehicle 200, according to some aspects. The method 500 can include actuating, responsive to a receipt of an instruction, an actuator 102 to couple a second linkage 110 coupled with a first linkage 108 to couple an interior release handle 106 with a door latch mechanism 104 to permit internal operation of the door 100 at ACT 510. For example, the instruction can be received from a selection of a switch, button, or vehicle display input device (e.g., touchscreen). The instruction can be provided over a data link separate from a power signal to operate the motor 306, or as a provision of a power signal for the motor 306 to cause a relative rotation between the first member 302 and the second member 304 of the actuator 102. For example, the instruction can be provided according to a first polarity to permit internal operation of the door 100, and a second instruction can be provided according to a second polarity to prevent internal operation of the door 100.

The method can include maintaining a position of the actuator 102 upon a loss of power. For example, upon a loss of power, the motor can maintain a position, so that the interior release handle 106 can permit or prevent internal operation of the door 100 (e.g., actuating the door latch mechanism 104 according to an actuation of the interior release handle 106). For example, actuating the actuator 102 to couple the second linkage 110 with the second linkage can transfer a displacement of the second linkage 110 to the first linkage 108 when the actuator 102 is configured to permit operation of the interior release handle 106, even if the motor 306 is not powered. The actuation of the actuator 102 can include engaging the motor 306 to rotate a protrusion to align with a first channel portion 316 of a second member 304 to pass the protrusion along the channel upon an actuation of the interior release handle 106.

The method can include detecting a radial position of a rotatable member of the actuator 102 (e.g., the first member 302 or the second member 304). For example, the detection can be performed by accessing a memory of a controller coupled with the motor 306 to detect a last instruction provided to the motor 306, or by accessing sensor data to detect a position of the motor 306 or another component of the actuator 102, such as the first member 302, the second member 304, the mating gear 308, or an engagement feature, such as gear pins 310 or another geared wheel. The detected radial position can be displayed, such as via an in-vehicle display, as may include a center information display (CID), instrument cluster display (ICD), an LED display or mechanical position of a front or rear seat control switch, or other display.

Some of the description herein emphasizes the structural independence of the aspects of the system components or groupings of operations and responsibilities of these system components. Other groupings that execute similar overall operations are within the scope of the present application. Modules can be implemented in hardware or as computer instructions on a non-transient computer readable storage medium, and modules can be distributed across various hardware or computer-based components.

The systems described above can provide multiple ones of any or each of those components and these components can be provided on either a standalone system or on multiple instantiation in a distributed system. In addition, the systems and methods described above can be provided as one or more computer-readable programs or executable instructions embodied on or in one or more articles of manufacture. The article of manufacture can be cloud storage, a hard disk, a CD-ROM, a flash memory card, a PROM, a RAM, a ROM, or a magnetic tape. In general, the computer-readable programs can be implemented in any programming language, such as LISP, PERL, C, C++, C#, PROLOG, or in any byte code language such as JAVA. The software programs or executable instructions can be stored on or in one or more articles of manufacture as object code.

Example and non-limiting module implementation elements include sensors providing any value determined herein, sensors providing any value that is a precursor to a value determined herein, datalink or network hardware including communication chips, oscillating crystals, communication links, cables, twisted pair wiring, coaxial wiring, shielded wiring, transmitters, receivers, or transceivers, logic circuits, hard-wired logic circuits, reconfigurable logic circuits in a particular non-transient state configured according to the module specification, any actuator including at least an electrical, hydraulic, or pneumatic actuator, a solenoid, an op-amp, analog control elements (springs, filters, integrators, adders, dividers, gain elements), or digital control elements.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computing device”, “component” or “data processing apparatus” or the like encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

For example, descriptions of positive and negative electrical characteristics may be reversed. Further relative parallel, perpendicular, vertical or other positioning or orientation descriptions include variations within +/−10% or +/−10 degrees of pure vertical, parallel or perpendicular positioning. References to “approximately,” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

1. A system to operate a vehicle door, comprising:
an actuator to couple a second linkage of a door latch mechanism with a first linkage of an interior release handle, the actuator including a motor to:
actuate the actuator to decouple the second linkage from the first linkage responsive to a receipt of a first instruction to prevent internal operation of the vehicle door; and
actuate, responsive to receipt of a second instruction, the actuator to couple the second linkage with the first linkage to couple the interior release handle with the door latch mechanism to permit internal operation of the vehicle door wherein the actuator comprises:
a first member comprising an inner sidewall defining an axial opening extending along a first direction to receive a second member and a protrusion extending from the inner sidewall; and
the second member comprising a channel in an outer surface of a cylindrical portion to receive the protrusion, the channel comprising a first portion extending along the first direction and a second portion extending circumferentially about the cylindrical portion.

2. The system of claim 1, wherein the
first member is configured to receive a first end of the second linkage, the first member comprising a body having a cylindrical portion extending along a first direction; and
a second member overlapping with the first member along the first direction to, at a first end of the second member:
according to a first radial position between the first member and the second member, arrest a movement between the first member and the second member along the first direction according to an interference between a protrusion of one of the first member or the second member with a sidewall of a channel of the other of the first member or the second member; and
according to second radial position between the first member and the second member, allow telescopic movement of one of the first member or the second member into the other of the first member or the second member.

3. (canceled)

4. The system of claim 1, wherein:
a first face of the first member of the actuator defines a notch to receive the second linkage;
a body of the first member defines an opening in fluid communication with the notch to receive a first end stop of the second linkage and retain the first end stop along a second face of the first member disposed oppositely from the first face of the first member; and
a first face of a second end of the second member defines a notch to receive the first linkage.

5. The system of claim 1, comprising:
a mating gear coupling the motor with a plurality of gear pins of the first member of the actuator.

6. The system of claim 1, wherein the
first member comprises a plurality of tapered gear pins to mate with a mating gear coupled with a shaft of the motor.

7. The system of claim 1, further comprising a housing comprising:
the first member of the actuator;
the second member of the actuator;
the motor; and
a spring having a first end abutting a face of the second member and a second end abutting an inner sidewall of the housing that:
in a retracted state, aligns, a protrusion of the second member with a first portion of a channel of the first member extending along a first direction; and
in an extended state, aligns, along the first direction, the protrusion of the second member with a second portion of the channel of the first member extending circumferentially about a cylindrical portion of the first member, wherein the first portion of the channel and a second portion of the channel are in fluid communication at an intersection point,
wherein the motor is configured to rotate the first member, with the spring in an extended state, to:
a first radial position to radially align the protrusion with the intersection point; and
a second radial position to radially offset the protrusion from the intersection point.

8. The system of claim 1, wherein the system further comprises a controller to:
receive, from a user interface, an indication to disengage the interior release handle; and
generate, responsive to the indication, a control signal to rotate the first member to the actuator relative to the second member of the actuator to decouple the interior release handle from the door latch mechanism.

9. The system of claim 1, wherein the system further comprises a sensor to detect an indication of a radial position of the first member of the actuator and a controller to:
receive, from the sensor, the indication of the radial position of the first member; and
cause a display indicating a state of the actuator based on the radial position.

10. A method of door operation for a vehicle, comprising:
actuating, responsive to a receipt of an instruction, an actuator to couple a first linkage coupled with a second linkage to couple an interior release handle with a door latch mechanism to permit internal operation of the door wherein the actuator comprises:
a first member comprising an inner sidewall defining an axial opening extending along a first direction to receive a second member and a protrusion extending from the inner sidewall; and
the second member comprising a channel in an outer surface of a cylindrical portion to receive the protrusion, the channel comprising a first portion extending along the first direction and a second portion extending circumferentially about the cylindrical portion.

11. The method of claim 10, comprising:
maintaining, upon a loss of power to the actuator, a position of the actuator.

12. The method of claim 10, wherein actuating the actuator to couple the first linkage with the second linkage comprises:
engaging a motor to rotate a protrusion of the first member to align the protrusion with a first channel portion of the second member to pass the protrusion into the channel upon an actuation of the interior release handle to transfer a displacement of the first linkage to the second linkage.

13. The method of claim 10, wherein the
first member is configured to receive a first end of the second linkage, the first member comprising a body having a cylindrical portion extending along a first direction; and
the second member overlapping with the first member along the first direction to, at a first end of the second member:
according to a first radial position between the first member and the second member, arrest a movement between the first member and the second member along the first direction according to an interference between a protrusion of one of the first member or the second member with a sidewall of a channel of the other of the first member or the second member; and
according to second radial position between the first member and the second member, allow telescopic movement of one of the first member or the second member into the other of the first member or the second member.

14. (canceled)

15. The method of claim 10, wherein:
a first face of the first member of the actuator defines a notch to receive the second linkage;
a body of the first member defines an opening in fluid communication with the notch to receive a first end stop of the second linkage and retain the first end stop along a second face of the first member disposed oppositely from the first face of the first member; and
a first face of a second end of the second member defines a notch to receive the first linkage.

16. The method of claim 10, wherein actuating the actuator to couple the first linkage with the second linkage comprises:
mating pin gears of a motor with the first member, to align a protrusion of the first member with a first channel portion of the second member.

17. The method of claim 10, further comprising:
detecting a radial position of a rotatable member of the actuator; and
presenting the detected radial position on an in-vehicle display.

18. The method of claim 10, further comprising:
actuating the actuator to decouple the first linkage from the second linkage by aligning a protrusion of the first member with a second channel portion of the second member, the second channel portion extending perpendicular to a force applied to the first linkage by the interior release handle.

19. An electric vehicle comprising:
a door comprising:
a door latch mechanism to latch the door closed, the door latch mechanism coupled with a second linkage;
an interior release handle coupled with a first linkage; and
an actuator to couple the second linkage with the first linkage, the actuator including a motor to:
actuate the actuator to decouple the second linkage from the first linkage responsive to a receipt of a first instruction to prevent internal operation of the door; and
actuate the actuator to couple the second linkage with the first linkage responsive to a receipt of a second instruction to permit internal operation of the door wherein the actuator comprises:
a first member to receive a first end of the second linkage, the first member comprising a body having a cylindrical portion extending along a first direction; and
a second member overlapping with the first member along the first direction to, at a first end of the second member:
according to a first radial position between the first member and the second member, arrest a movement between the first member and the second member along the first direction according to an interference between a protrusion of one of the first member or the second member with a sidewall of a channel of the other of the first member or the second member; and
according to second radial position between the first member and the second member, allow telescopic movement of one of the first member or the second member into the other of the first member or the second member.

20. (canceled)
